(19) United States
(12) Patent Application Publication
(10) Pub. No.: US 2022/0369673 A1
(43) Pub. Date: Nov. 24, 2022

(54) Process and System for Processing Fruit and/or Vegetable

(71) Applicant: Tropicana Products, Inc., Bradenton, FL (US)

(72) Inventors: Stephanie Brown, Chicago, IL (US); Teodoro Rivera, Algonquin, IL (US); John Bovastro, Barrington, IL (US)

(21) Appl. No.: 17/323,620

(22) Filed: May 18, 2021

(51) Int. Cl. A23L 2/84; A23L 2/04; A23L 2/68; A23L 2/46; A23L 2/74; A23L 2/78; A23L 2/385

(52) U.S. Cl. CPC A23L 2/84; A23L 2/04; A23L 2/68; A23L 2/46; A23L 2/74; A23L 2/78; A23L 2/385; A23V 2002/00

(57) ABSTRACT

A process and system to produce a fruit or vegetable juice concentrate having clean flavor, color, and aroma with a Brix value between about 30 to about 70 The process includes crushing raw fruit or vegetable to form a juice puree that is enzymatically treated to improve overall yield of juice concentrate. The enzymatically treated juice puree is directed to a separator to separate the liquid juice from the solids. The liquid juice is pasteurized, clarified, and then treated to remove or reduce off-flavor and/or off-flavor precursor compounds to produce the fruit or vegetable juice concentrate.

The present disclosure relates to processes and systems for processing a fruit and/or vegetable.

### BACKGROUND

In an effort to provide consumers with healthy drink options, it is desired to provide processes for obtaining juices from fruits and vegetables. One difficult occurs with the those fruits and vegetables that are large compared to, for example, oranges and apples. Such fruits and vegetables include, but are not limited to, watermelon, musk melon, honeydew melon, winter melon, cantaloupe, squash, pumpkins, and the like. One particular fruit of interest is winter melon.

Winter melon (also spelled as wintermelon) is the only member of the Genus Benincasa and it is known as Benincasa hispida. Winter melon is also commonly known as wax gourd, ash gourd, white gourd, winter gourd, tallow gourd, ash pumpkin, Chinese preserving melon and (Alu) Puhul. Winter melon is a vine grown for its very large fruit, eaten as a vegetable when mature.

Winter melon contains a substantial amount of water, is low in calories, fat, protein, and carbohydrates, but is considered to be rich in fiber and to be a good source of flavonoids and carotenes. The fruit is most often cubed, boiled, and eaten on its own or added to soups and stews. It can also be baked, fried, candied, or simply peeled and added to salads, or eaten raw.

One challenge with the use of winter melon is the presence of various off flavor and off-flavor precursor compounds such as hexanal, dimethyl disulfide, dimethyl trisulfide, dimethyl sulfide, and methanethiol. The following description describes a process for processing winter melon to provide a suitable winter melon juice. It should be noted and appreciated that the following description will refer to winter melon, this is simply for ease of reference and it is intended, where appropriate that a mention of winter melon likewise refers to other fruits and vegetables.

### SUMMARY

According to one aspect of the disclosure, a system for processing fruits and vegetables is described. As just noted, the system is contemplated to be applicable to any fruit or vegetable but it is believed to be more applicable to larger fruits and vegetables such, but not limited to, watermelon, musk melon, honeydew melon, cantaloupe, winter melon, squash, pumpkins, and the like. Further, for ease of reference, reference will be made to winter melon, although in appropriate instances, one of skill will appreciate that such reference applies equally to other fruits and vegetables.

The system includes, in the following sequence, a washer to remove a sticky wax-like substance that sometimes forms on the surface; a crusher, a grinder, an enzyme treatment apparatus, a separator, a pasteurizer, and a clarifier. The system may also include one or more apparatuses to remove off-flavor or off-flavor precursors. To this end, the system may include an ultrafiltration unit followed by an evaporator or concentrator, from which a winter melon concentrate can be collected. The winter melon concentrate may be diluted with water to provide a finished low Brix low calorie winter melon juice. Alternatively or additionally, the system may include one or more ion exchange units containing resins that possess a chemical structure to bind off-flavor and off-flavor precursor compounds. The ion exchange effluent can be collected.

According to another aspect, a method or process for producing a winter melon juice having a clean flavor, color, and aroma with a Brix value between about 1 to about 4. The process includes cleaning the raw winter melon, crushing the cleaned raw winter melon, grinding the crushed winter melon to produce a slurry that is directed to a tank where the slurry is treated with an enzyme composition to form an enzyme treated slurry. The enzyme treated slurry is directed to a separator to separate the solids (pomace, peel, and seed fragments) from the liquid, which is then directed to a pasteurizer which will effectively deactivate the enzymes and micro-load. Thereafter, the output of the pasteurizer is directed to a clarifier to produce a clarified juice that may be stored in a tank.

The clarified juice may then be treated to remove off-flavor and off-flavor precursor compounds. The treatment may include passing the clarified juice through on or more ion exchange beds to produce the finished winter melon juice, which may then be appropriately packaged. Alternatively, the clarified juice may be filtered using ultrafiltration, reverse osmosis, or both, and thereafter concentrated using, for example, an evaporator, which may be effective in removing volatile off-flavor or off-flavor precursor compounds. In yet another alternative, the effluent of the ion exchange beds may be directed to a filtration system that may include microfiltration, ultrafiltration, nanofiltration, reverse osmosis, or combinations. The effluent of the filtration system may be directed to one or more of a carbon, bentonite, and carbon-bentonite beds, which may be effective in further removing off flavors and colors. Alternatively or additionally, the effluent of the filtration system or beds, respectively, may then be directed to a concentrator such as an evaporator, which may be effective in removing volatile off-flavor or off-flavor precursor compounds.

Unless otherwise explicitly noted, all percentages in the disclosure refer to a percent by weight.

### BRIEF DESCRIPTION OF THE DRAWINGS

The following description accompanies the drawings, all given by way of non-limiting examples that will be useful to understand how the described process and system may be embodied.

FIG. 1 is a schematic of a system for processing fruits and vegetables.

FIG. 2 shows the reduction in off-flavor levels achieved by various sub-systems useful in the described processing system when processing winter melon.

FIG. 3 shows the calculated overall winter melon juice yield based on the results of comparative trials where winter melon was processed according to the system shown in FIG. 1.

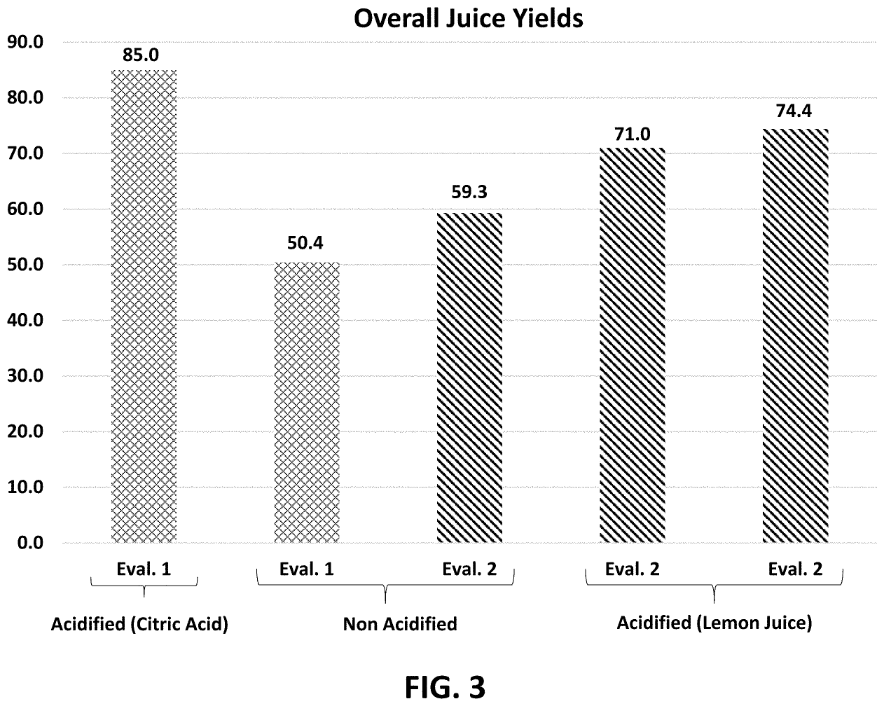

### DESCRIPTION

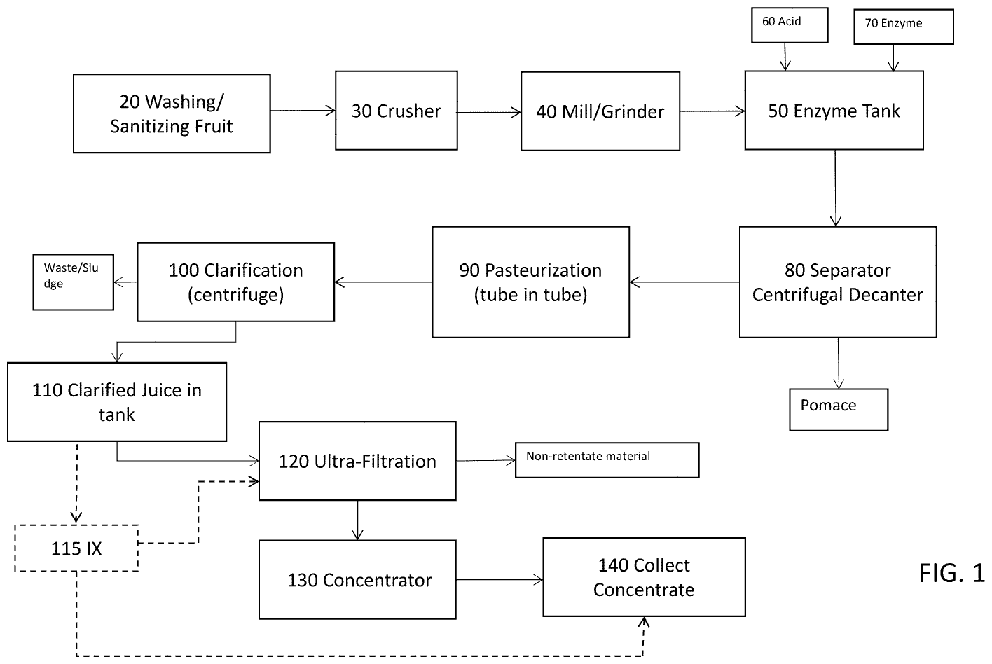

Referring now to FIG. 1, a system 10 for processing fruits and vegetables is shown. The system 10 is configured to process harvested winter melon to produce a finished juice 140. The system includes enzymatic treatment, which increases the yield of the process and one or more apparatuses to remove off-flavor or off-flavor precursors to provide a finished winter melon juice having a desirable clean flavor, color, and aroma with a Brix value between about 1 to about 4.

The system includes a washing apparatus 20 that is effective to remove debris and the white powder that may be found on the surface of the winter melon and causes the surface to be sticky when wet. Any suitable washing apparatus may be used so long as it is effective to remove the debris from the surface of the winter melon.

Washing may be accomplished by dumping the winter melon into troughs of moving water, separating them from the water, and spray washing the winter melon. They can also be treated with strong water sprays as they move along a roller-type conveyor. The wash water may contain chlorine (about 5 to 20 ppm) or other disinfectant.

Subsequent to washing, the winter melons are conveyed to a crushing apparatus 30 to liberate the liquid in the winter melon and to reduce the size of the washed raw winter melon to solids having a size in the range of about 15 cm to about 50 cm in effective diameter. The term “effective diameter” refers to a measure such that the area of a non-circular cross section of the resulting crushed winter melon would be approximately the same as the area of a circular cross section of the resulting crushed winter melon.

Thereafter, the crushed winter melon is directed to a milling or grinding apparatus 40 to form a winter melon juice puree or slurry having solids in a size range from about 0.01 cm to about 1 cm. The puree or slurry is directed to an enzyme treatment tank 50 for enzymatic treatment.

Treatment of the juice puree with certain enzymes, such as pectinase, or multi-enzyme combinations (e.g., pectinase, glycosidase, carbohydrases, including arabanase, cellulase, beta-glucanase, hemicellulase, and xylanase) can help hydrolyze pectin and fibers, clarify the puree or slurry, reduce the viscosity of the puree or slurry, and remove off-flavor materials and precursors. In some embodiments, pectinase may be used to remove any pectin from the juice puree, provide clarity, and prevent gelling of the puree or slurry. Suitable amounts of enzymes 70, for example pectinase, added to the puree or slurry are from about 0.001% to about 1%, or from about 0.005% to about 0.05% (dry basis). The pectinase is allowed to react with the puree or slurry for at least about 0.5 hr., or from about 1 hr. to about 2 hr., at a temperature of from about 10° C. to about 60° C., or from about 40° C. to about 50° C. The pectinase may be allowed to react with the puree or slurry for a period of time to achieve substantial hydrolysis of pectin present in the puree or slurry.

In some embodiments, the puree or slurry may be treated with a multi-enzyme combination that may contain one or more of including arabanase, cellulase, beta-glucanase, hemicellulase, and xylanase. The multi-enzyme combination may be added in an amount from about 0.1 to about 1 kg per ton of puree or slurry. In other embodiments, the puree or slurry may be treated with a pectinase and the multi-enzyme combination.

In some embodiments, one or more acids 60 are added to the enzyme treatment tank 50 before or at the same time as the enzymes are added to provide a pH in the enzyme treatment tank 50 in the range of about 3.5 to about 4.0 or from about 3.6 to about 3.9, or about 3.8 to about 3.9. The acid may be any suitable food grade acid and, in some instances the acid may be one or more of citric acid, malic acid, lactic acid, tartaric acid, acetic acid, phosphoric acid, sulfuric acid, or hydrochloric acid. It is contemplated that the citric acid may be provided from one or more citrus juices such as lemon or lime juice so that the resulting winter melon product (either the concentrate or the finished juice) can be classified as “all natural”.

Advantageously, it has been found that when the pH of the puree or slurry is within the range of about 3.5 to about 4.0, the puree or slurry that is enzymatically treated results in an overall yield of finished winter melon juice that is substantially greater than when the puree or slurry is enzymatically treated but without the addition of an acid. For example, it was found that the addition of acid increased the overall yield of finished winter melon to more than 70% compared to the overall yield of less than about 60% for a finished winter melon with no added acid.

After the enzymatic treatment the enzymatically treated puree or slurry is directed to a solids separator 80 to separate the liquid juice from the solids (pomace) and to form a liquid juice fraction. In one aspect, the solids separator 80 can be a centrifugal decanter that is effective to produce a liquid juice fraction with a Brix value of about 3.0 to about 5.0 or about 4.0 and a solids fraction with an average moisture content between about 75% and about 90% or about 80%, 81%, 82%, 83%, 84%, 85%, 86%, 87%, 88%, or about 89%.

The liquid juice fraction may be pasteurized 90 to deactivate the enzymes. The pasteurization 90 may be accomplished using any suitable pasteurization apparatus such as a tube-in-tube pasteurization apparatus. In some aspects, the pasteurization may be conducted at a temperature greater than 175° F., or about 180° F., or within a range between about 180° F. to about 200° F., and in some instances the temperature of pasteurization may be conducted at an average temperature of about 196° F. The hold time may be in the range from about 10 s (seconds) to about 180 s, or about 10 s to about 120 s, or about 10 s to about 60 s, or about 15 s to about 45 s, or about 20 s to about 40, to about 25 s to about 35 s, or about 30 s.

Thereafter, the pasteurized juice is clarified 100 to form a clarified juice having a Brix value between about 2.0 to about 5.0 that may be directed to a tank 110 for storage or further treatment. In some aspects, the clarification is conducted under conditions to provide a sinking solids content from about 0.1% to about 2%, or about 1% or less than about 1%. The clarification may be accomplished in any suitable manner, but in some aspects, the clarification is performed using a centrifugal separator that is effective to separate waste/sludge from clarified juice.

It has been found that the clarified juice may contain off-flavor and/or off-flavor precursor compounds, which may include one or more of hexanal, (E)-2-hexenal, hexanol, limonene, nonanal, (E,E)-2,6-nonadienal, (E)-2-Nonenal, dimethyl disulfide, dimethyl trisulfide, dimethyl sulfide, methanethiol. In some instances, it would be desirable to remove or reduce their concentration.

In one embodiment, the clarified juice is directed to an ultrafiltration or reverse osmosis apparatus 120 where the off-flavor and/or off-flavor precursor compounds are retained such that the filtrate contains an amount of off-flavor and/or off-flavor precursor compounds that is less than the amount off-flavor and/or off-flavor precursor compounds present in the clarified juice. Thereafter, the filtrate may be directed to a concentrator 130 such as an evaporator where volatile off-flavor and/or off-flavor precursor compounds may be removed to produce a finished winter melon concentrate 140 that may be collected in tank for packaging or may be packaged directly from the effluent of the concentrator. In this regard, the finished winter melon concentrate 140 may be collected and frozen for shipping. Alternatively, the concentrate 140 may be collected, aseptically processed, and refrigerated for shipping.

The concentrate will have a Brix content between about 30° to about 70°, from about 40° to about 50° and in some instances about 45° and will have a pH in the range of about 3 to about 4.5, or from about 3.5 to 3.9.

It is contemplated that the concentrate may be diluted with water to provide a low-calorie finished winter melon juice having a Brix content between about 1° and about 5° or between about 2° and about 3° and in some instances a Brix content between about 2.4° and about 2.8°, or about 2.6°. To this end, it is also contemplated that finished low-calorie low Brix winter melon juice can be mixed with other juices such as orange juice to provide a lower calorie sugar reduced 100% juice, such as 100% orange juice.

As shown in FIG. 1, an alternative process step may include directing the clarified juice to an ion exchange apparatus 115 that contains one or more suitable resins to bind with and remove off-flavor and/or off-flavor precursor compounds to produce an ion exchange effluent. The suitable resins may include anionic and cationic resins and, in some instances are cationic resins. Alternatively, the ion exchange effluent may be directed to the ultra-filtration apparatus 120 and processed as described above.

### EXAMPLES

### Example 1

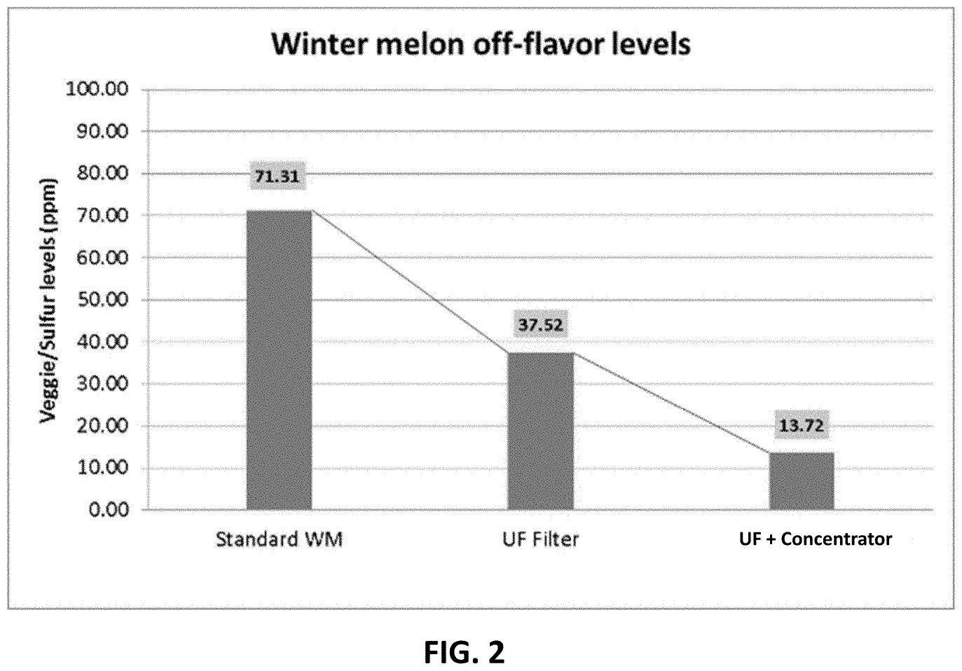

With reference to FIG. 2, off-flavor and/or off-flavor precursor compounds were measured, in particular sulfur compounds that are known to present an off-flavor and/or are known to be off-flavor precursor compounds, present in raw winter melon was measured and found to be about 71.31 ppm. Thereafter, the raw winter melon was processed according to the process shown in FIG. 1 and samples of the effluent of the ultra-filtration unit and the effluent of the concentrator (after having passed through the ultra-filtration unit) were taken. In this processing no ion exchange treatment was used. It was found that the effluent of the ultra-filtration unit contained about 37.52 ppm of off-flavor and/or off-flavor precursor compounds and the effluent of the concentrator contained about 13.72 ppm off-flavor and/or off-flavor precursor compounds. It will be appreciated that the process according to FIG. 1 is effective in reducing the amount of off-flavor and/or off-flavor precursor compounds.

It is believed that passing the effluent of the clarifier 110 through an ion exchange system 115 prior to the ultra-filtration 120 would reduce the amount of off-flavor and/or off-flavor precursor compounds in the effluent of the concentrator to levels less than that measured in Example 1, i.e., less than about 13.72 ppm.

### Example 2

Two trials (Evaluation 1) were conducted using the process shown in FIG. 1. In Evaluation 1, two processes were conducted. In the first process an acid (citric acid) was added to the enzyme tank while in the second process no acid was added to the enzyme tank. Other than that difference, the winter melon was processed in a substantially identical manner. The overall yield of the collected winter melon concentrate was calculated and it was determined that when the acid was added, the overall yield was approximately 85%; whereas when no acid was added, the overall yield was only about 50.4%. From this, it will be appreciated that the addition of acid provided an benefit to the overall yield of the process according to FIG. 1.

Subsequently, three trials (Evaluation 2) were conducted using the process shown in FIG. 1. In Evaluation 2, three processes were conducted. In the first process no acid was added to the enzyme tank while in the second and third process acid (lemon juice) was added to the enzyme tank. Other than that difference, the winter melon was processed in a substantially identical manner. The overall yield of the collected winter melon concentrate was calculated and it was determined that when no acid was added, the overall yield was approximately 59.3%; whereas when acid was added, the overall yield in one process was about 71% while in the other process it was 74.4%. From this, it will be appreciated that the addition of acid in the form of lemon provided an benefit to the overall yield of the process according to FIG. 1.

While the overall yield when using lemon juice as the added acid was less than when using citric acid, the overall yield was greater than if no acid was added. In addition, the use of lemon juice provides a labeling advantage in that if the resulting winter melon juice is combined with another juice such as orange juice, the resulting orange juice can be identified as 100% juice, which is not the case if citric acid is used as the added acid.

While the concepts of the present disclosure are susceptible to various modifications and alternative forms, specific exemplary embodiments of the disclosure have been shown by way of example in the drawings. It should be understood, however, that there is no intent to limit the concepts of the present disclosure to the particular disclosed forms; the intention is to cover all modifications, equivalents, and alternatives falling within the spirit and scope of the invention as defined by the claims.

1. A process for preparing juice from a fruit or vegetable that comprises the following sequential steps:
crushing raw fruit or vegetable to provide a juice puree that is directed to a tank;
mixing one or more enzymes with the juice puree to hydrolyze pectin and fiber;
separating liquid juice from solids;
pasteurizing the liquid juice;
clarifying the pasteurized liquid juice to form a clarified juice; and
treating the clarified the clarified juice to remove off-flavor and off-flavor precursor compounds to form a juice concentrate.

2. The process of claim 1 wherein the treating comprises filtering the clarified juice to provide a filtrate that is concentrated to provide the juice concentrate.

3. The process of claim 4 wherein the juice concentrate has a Brix value in the range of about 30 to about 70.

4. The process of claim 1 wherein the treating comprises passing the clarified juice through an ion exchange apparatus that contains one or more ion exchange resins.

5. The process of claim 4 further comprising filtering the effluent of the ion exchange apparatus to provide a filtrate.

6. The process of claim 5 further comprising concentrating the filtrate to provide the juice concentrate.

7. The process of claim 1 further comprising adding an acid before, during, or after the mixing the one or more enzymes with the juice puree to form a mixture having a pH in the range of 3.5 to 4.0.
